(19) United States
(12) Patent Application Publication
(10) Pub. No.: US 2017/0332014 A1
(43) Pub. Date: Nov. 16, 2017

(54) METHOD FOR TRANSFORMING WIDE-ANGLE IMAGE TO MAP PROJECTION IMAGE AND PERSPECTIVE PROJECTION IMAGE

(71) Applicant: Imay Software Co., Ltd., Taipei (TW)

(72) Inventor: Kuang-Yen Shih, Taipei (TW)

(21) Appl. No.: 15/593,346

(22) Filed: May 12, 2017

(30) Foreign Application Priority Data
May 13, 2016 (CN) 201610317292.0

(51) Int. Cl. H04N 5/232; H04N 5/265

(52) U.S. Cl. CPC H04N 5/23238; H04N 5/265

(57) ABSTRACT

The present invention provides a method for transforming a wide-angle image to a map projection image that includes the steps of: capturing a wide-angle image; choosing an azimuthal coordinate model and introducing the wide-angle image into the chosen azimuthal coordinate model to obtain an azimuthal image; and generating a compensation image by using the azimuthal image to generate the map projection image. The present invention also provides a method for transforming a wide-angle image to a perspective projection image that includes the same steps. The present invention facilitates generation of virtual reality images.

### BACKGROUND OF THE INVENTION

### 1. Field of the Invention

The present invention generally relates to a method for processing images, more particularly to a method for transforming a wide-angle image to a map projection image and a perspective projection image.

### 2. Description of the Prior Art

Equirectangular projection is also called spherical projection or geography projection, and the ranges of its longitude and latitude are between −180° to 180° and −90° to 90° respectively. Therefore, equirectangular projection is a standard image format, so as to broadly apply to immersive virtual reality.

The main purpose of the virtual reality image/video is to output equirectangular projection images/video streams. For the panoramic video software in the present marketing, the panoramic video is always made by stitching several images/videos from cameras so as to generate an equirectangular projection.

A plurality of key components to generate virtual reality image or video stream are listed below:
1. Camera rig;
2. Computer, which is with high-end graphics card to provide a powerful image and the function of instant stitching;
3. Stitching software, which must be real-time and there is no lag, but also allows people to make the appropriate adjustments; and
4. Image/video encoder.

However, a tremendous technical shortcoming has never been solved, that is, for instance, an external display device cannot obtain the operations and outputs of all virtual reality requires instantly and directly.

### SUMMARY OF THE INVENTION

The present invention provides a method for transforming a wide-angle image to a map projection image in order to solve a couple of technical problems in prior arts.

The present invention provides a method for transforming a wide-angle image to a perspective projection image in order to solve a couple of technical problems in prior arts.

To approach aforesaid objectives, the method for transforming a wide-angle image to a map projection image has the steps of: capturing a wide-angle image; choosing an azimuthal coordinate model and introducing the wide-angle image into the chosen azimuthal coordinate model to obtain an azimuthal image; and generating a compensation image by using the azimuthal image to generate the map projection image.

Preferably, the step of generating the compensation image by using the azimuthal image to generate the map projection image further comprises the steps of: defining a compensation area outside the range of the longitude of the azimuthal image, forming the compensation image according to the compensation area of the azimuthal image; and co-projecting the azimuthal image and the compensation image into the map projection image by a map projection method.

Preferably, the range of the longitude of the azimuthal image is 180° and the range of the longitude of the compensation image is 180°.

Preferably, the compensation image is a mirror projection image or a duplicate projection image, f(λ, ψ) is defined as a projection function of the azimuthal image projected into the map projection image, λ and ψ are a longitude and a latitude respectively, f′(λ, ψ) is defined as a compensation function of the compensation area, the relationships of the mirror projection image and the azimuthal image are as that of:

$${f}^{′} ( λ , ψ ) = \{ \begin{matrix}f ( π - λ , Ψ ) , & λ ≧ π / 2 \\ f ( - π - λ , ψ ) , & λ ≦ - π / 2\end{matrix} ,$$

and
the relationships of the duplicate projection image and the azimuthal image are as that of:

$${f}^{′} ( λ , ψ ) = \{ \begin{matrix}f ( - π + λ , ψ ) , & λ ≧ π / 2 \\ f ( π + λ , ψ ) , & λ ≦ - π / 2\end{matrix} .$$

Preferably, the method for transforming the wide-angle image to the map projection image further has the step of: horizontally displacing an equirectangular image by functions of f(λ+λ₀, φ) and f′(λ+λ₀, φ), wherein the λ₀ is defined as a longitude displacement angle and the map projection method is an equirectangular method and the map projection image is an equirectangular image.

Preferably, the map projection method is an equirectangular projection method and the map projection image is an equirectangular image, and the method for transforming the wide-angle image to the map projection image further has the step of: cropping a vertical section from a longitude φ range of −90° to 90° of an equirectangular image to output a cylindrical projection image.

Preferably, the method for transforming the wide-angle image to the map projection image further has the step of: referring to the coordinates of the longitude and the latitude of a position to obtain a new map projection image while the map projection image is dynamically changed.

Preferably, the map projection image of the method for transforming the wide-angle image to the map projection image is selected from the group consisting of: an azimuthal image, a cylindrical projection image and an equirectangular image.

Preferably, the azimuthal coordinate model of the method for transforming the wide-angle image to the map projection image is selected from the group consisting of: azimuthal equidistant projection, azimuthal stereographic projection and azimuthal orthographic projection.

To approach aforesaid objectives, the method for transforming a wide-angle image to a perspective projection image has the steps of: capturing a wide-angle image; choosing an azimuthal coordinate model and introducing the wide-angle image into the chosen azimuthal coordinate model to obtain an azimuthal image; and generating a compensation image by using the azimuthal image to generate the perspective projection image.

Preferably, the step of generating the compensation image by using the azimuthal image for the perspective projection image further has the steps of: defining the compensation area outside the range of the longitude of the azimuthal image, forming the compensation image according to the compensation area of the azimuthal image; and co-projecting the azimuthal image and the compensation image into the map projection image by a perspective projection method.

Preferably, the range of the longitude of the azimuthal image is 180° and the range of the longitude of the compensation image is 180°.

Preferably, the compensation image is a mirror projection image or a duplicate projection image, f(λ, ψ) is defined as a projection function of the azimuthal image projected into the perspective projection image, λ and ψ are a longitude and a latitude respectively, f′(λ, ψ) is defined as a compensation function of the compensation area, the relationship of the mirror projection image and the azimuthal image is:

$${f}^{′} ( λ , ψ ) = \{ \begin{matrix}f ( π - λ , ψ ) , & λ ≧ π / 2 \\ f ( - π - λ , ψ ) , & λ ≦ - π / 2\end{matrix} ,$$

and
the relationship of the duplicate projection image and the azimuthal image is:

$${f}^{′} ( λ , ψ ) = \{ \begin{matrix}f ( - π + λ , ψ ) , & λ ≧ π / 2 \\ f ( π + λ , ψ ) , & λ ≦ - π / 2\end{matrix} .$$

Preferably, the perspective projection method defines a sphere center as a view direction.

Preferably, the method for transforming the wide-angle image to the perspective projection image 11 further has the step of: dynamically changing a longitude, a latitude and a horizontal field of view angle (hFOV) of a view direction while in perspective projection, in order to obtain a new perspective projection image.

Preferably, the azimuthal coordinate model is selected from the group consisting of: azimuthal equidistant projection, azimuthal stereographic projection and azimuthal orthographic projection.

The methods of the present invention has the steps of using the azimuthal image to generate the compensation image, hence the prior arts of stitching images are no longer needed, so that a virtual reality image is easily approached.

Other and further features, advantages, and benefits of the invention will become apparent in the following description taken in conjunction with the following drawings. It is to be understood that the foregoing general description and following detailed description are exemplary and explanatory but are not to be restrictive of the invention. The accompanying drawings are incorporated in and constitute a part of this application and, together with the description, serve to explain the principles of the invention in general terms. Like numerals refer to like parts throughout the disclosure.

### BRIEF DESCRIPTION OF THE DRAWINGS

The objects, spirits, and advantages of the preferred embodiments of the present invention will be readily understood by the accompanying drawings and detailed descriptions, wherein:

FIG. 1 illustrates a schematic equirectangular projection image;

FIG. 2A illustrates a schematic view of a duplicate projection mode of the wide-angle image of FIG. 1;

FIG. 2B illustrates a schematic view of a mirror projection mode of the wide-angle image of FIG. 1;

FIG. 3A illustrates a schematic view in perspective projection;

FIG. 3B illustrates a schematic view of an object plane in perspective projection;

FIG. 4 illustrates a flow chart of a preferred embodiment of a method for transforming a wide-angle image to a map projection image of the present invention;

FIG. 5A illustrates a schematic view in azimuthal equidistant projection;

FIG. 5B illustrates a schematic view in azimuthal stereographic projection;

FIG. 5C illustrates a schematic view in azimuthal orthographic projection;

FIG. 5D illustrates a schematic view of an oval azimuthal coordinate model;

FIG. 6A illustrates a schematic view in polar aspect;

FIG. 6B illustrates a schematic view in equatorial aspect;

FIG. 6C illustrates a schematic view in oblique aspect;

FIG. 7A to FIG. 7E illustrate a flow chart of a preferred embodiment of a method for transforming a wide-angle image to a map projection image of the present invention;

FIG. 8A illustrates a schematic view of transforming the azimuthal image in FIG. 5A to a rectangular view;

FIG. 8B illustrates a schematic view of transforming the azimuthal image in FIG. 5B to a rectangular view;

FIG. 8C illustrates a schematic view of transforming the azimuthal image in FIG. 5C to a rectangular view;

FIG. 9A illustrates a schematic view of an azimuthal image of an azimuthal equidistant projection applied to the polar aspect;

FIG. 9B illustrates a schematic view of a rectangular image transformed by the azimuthal image in FIG. 9A;

FIG. 10A illustrates a schematic view of an azimuthal image of an azimuthal equidistant projection applied to the oblique aspect;

FIG. 10B illustrates a schematic view of a rectangular image transformed by the azimuthal image in FIG. 9A;

FIG. 11 illustrates a flow chart of a method for transforming an azimuthal image to an equirectangular image of the present invention;

FIG. 12A to FIG. 12F illustrate a flow chart of a preferred embodiment of a method for transforming a wide-angle image to a map projection image of the present invention;

FIG. 13 illustrates a flow chart of a preferred embodiment of a method for transforming a wide-angle image to a map projection image of the present invention; and

FIG. 14A to FIG. 14C illustrate three different perspective projection views of transforming the wide-angle image to the map projection image of the preferred embodiment of the present invention.

### DETAILED DESCRIPTION OF THE INVENTION

Following preferred embodiments and figures will be described in detail so as to achieve aforesaid objects.

The present invention discloses that a wide-angle image is presented by an azimuthal coordinate model, since an azimuthal projection model is able to correctly present the directions of the wide-angle image, and is comparatively identical to the features of wide-angle lenses with different types. The projection image of each of the wide-angle lenses is presented by a formula of the azimuthal projection model.

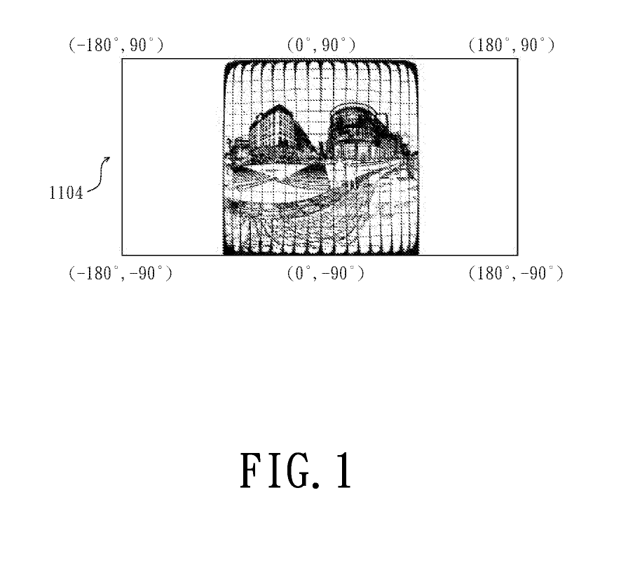

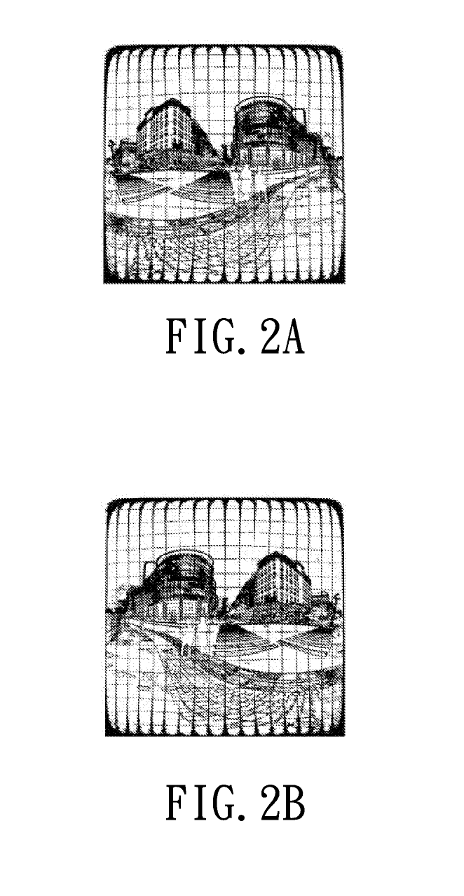

With reference to FIG. 1, a wide-angle image is projected into an equirectangular 1104 with 360°×180°, which means the longitude is 360° and the latitude is 180°, as it can be seen, the wide-angle image is not able to cover the whole area of the equirectangular 1104, so that the uncovered area must be compensated. Hence, the present invention provides two projection modes, which are a duplicate projection mode and a mirror projection mode, as shown in FIG. 2A and FIG. 2B respectively. Obviously the wide-angle image is capable of completely projecting into the equirectangular in order to output a virtual reality image, wherein the mirror projection mode offers a function of seamless stitching.

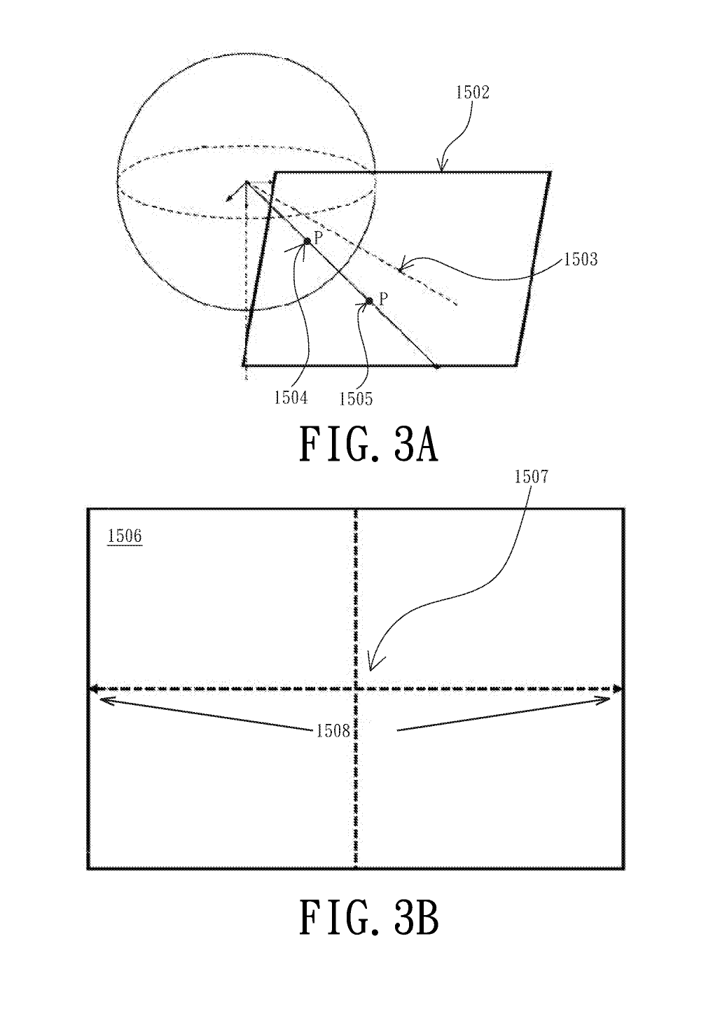

With reference to FIG. 3A and FIG. 3B, symbols 1501, 1502, 1506, 1503, 1505, 1504, 1507 and 1508 are defined as of a sphere center, an object plane, an object plane, a view direction (also a normal vector), a point on a perspective projection output object plane, a perspective projection point on a sphere surface corresponding to the point 1505, a longitude and a latitude of a view direction of perspective projection, and a horizontal field of view angle striding across the object plane 1506 and vertical to the center of the object plane 1506. As aforesaid, the projection of the compensation area can be used to operate an immersive virtual reality method by way of the wide-angle image, the longitude and latitude of the view direction 1503 (also the symbol 1507) and the horizontal field of view angle 1508. The importance is the range of operation is equal to the equirectangular, so as to provide a whole virtual reality environment.

The present invention outputs an equirectangular without stitching images, image compression, etc., that is, as aforementioned, an environment for the immersive virtual reality method is provided. That is to say, a remote display device can be operated to handle the wide-angle images of a camera, so as to output equivalent projection images, map projection images and perspective projection images.

The present invention provides a method to switch projections between an azimuthal coordinate and a cylindrical coordinate. Such method is suitable to the immersive operation as well for more interesting stuff.

The method provided by the invention is adequately adaptable to the image output of virtual reality. Generally speaking, in the range, between 165° to 200°, of field of view angle, those output virtual reality images are nice, even with different longitudes and latitudes. On the other hand, the sources of images may not be limited to complete full circle, rounded rectangular, oval, or wide-angle image which fully covers an image sensor (ie, a rectangular image). For cameras, they only need to install adequate wide-angle lenses, so as to obtain videos or images by way of the present invention.

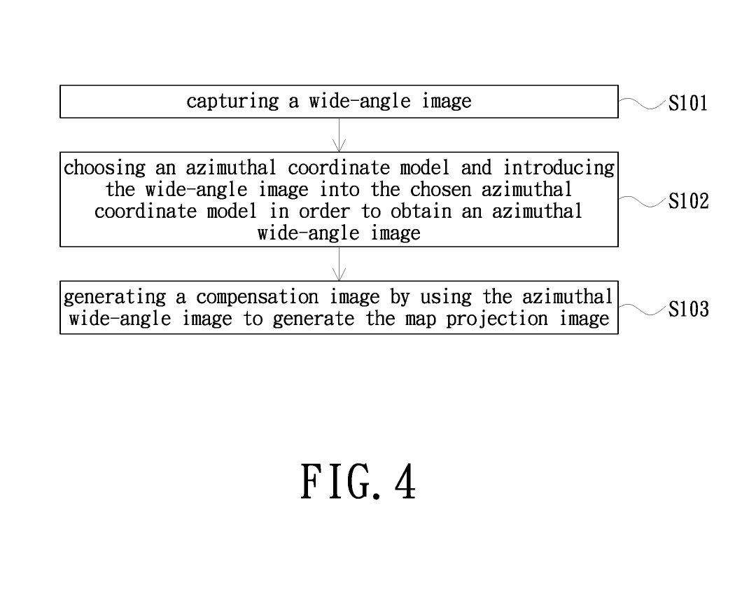

FIG. 4 illustrates a flow chart of a preferred embodiment of a method for transforming a wide-angle image to a map projection image of the present invention. As shown in figure, the first preferred embodiment of the method for transforming the wide-angle image to the map projection image of the present invention comprises the steps of:

S101: capturing a wide-angle image which is a projected image by a wide-angle lens and is from a single image source. For instance, an imagine-capturing device, as camera, shoots one or a couple of wide-angle images, wherein the wide-angle images are continuously shot, such as dynamic images or video.

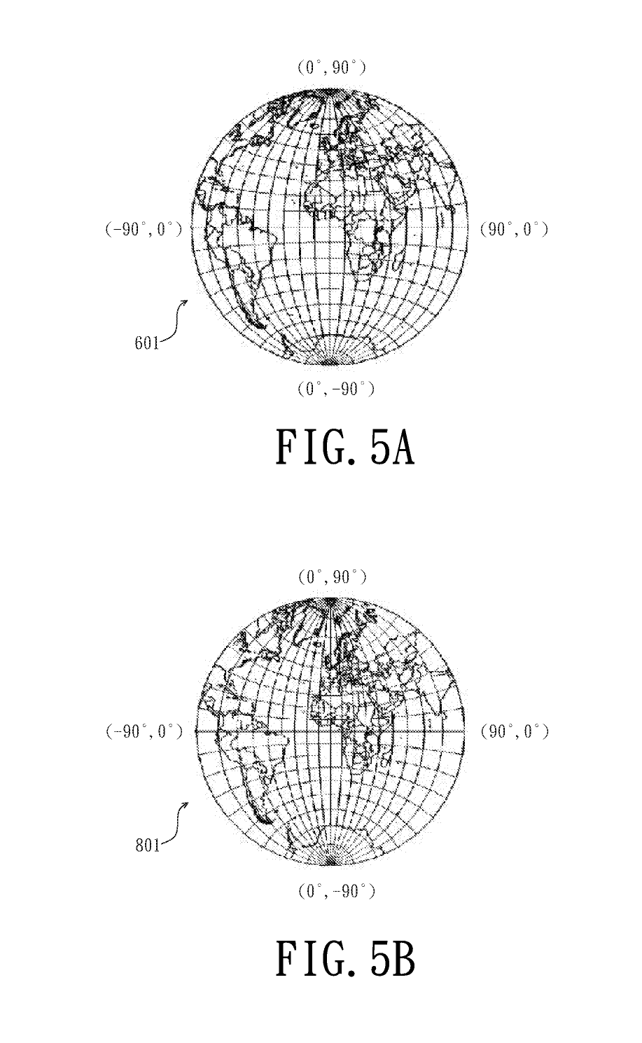

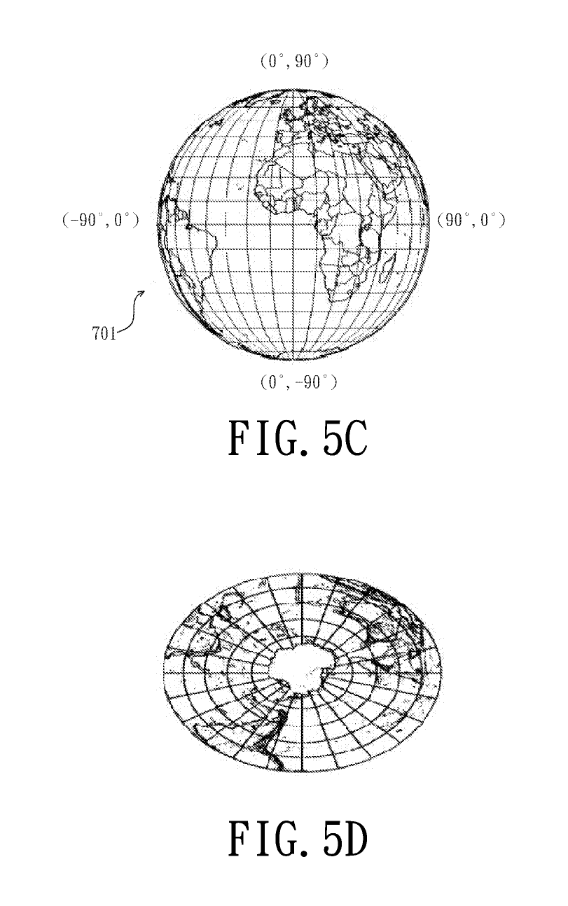

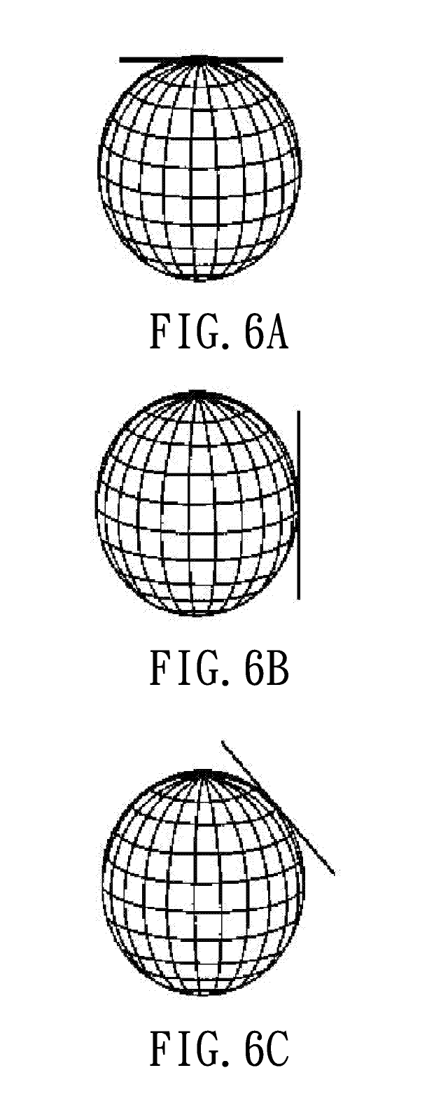

S102: choosing an azimuthal coordinate model and introducing the wide-angle image into the chosen azimuthal coordinate model in order to obtain an azimuthal image. The characteristics of the azimuthal coordinate model fit in with radiation symmetry. That is, the longitude line always shows a straight line in the pole position, so as to keep correct azimuth. According to latitude distributions and optical designs, the azimuthal coordinate model generally has three of an azimuthal equidistant projection, an azimuthal stereographic projection and an azimuthal orthographic projection, which are shown in FIG. 5A, FIG. 5B and FIG. 5C. The present embodiment can be an azimuthal equidistant projection, an azimuthal stereographic projection, an azimuthal orthographic projection, or other azimuthal coordinate models. The azimuthal coordinate model is not limited to a complete full circle or an oval, as shown in FIG. 5D, and its characteristic is that the longitude line always shows a straight line in the polar aspect. According to the reference plane of the contact point, as tangent or secant, and the aspect, the azimuthal projections mentioned above can be categorized as polar aspect, equatorial aspect and oblique aspect, which are shown in FIG. 6A, FIG. 6B and FIG. 6C. Further, the present embodiment can be applied to the equatorial aspect, the polar aspect and the oblique aspect simultaneously.

S103: generating a compensation image by using the azimuthal image to generate the map projection image. In detail, the step has the following steps of: defining a compensation area outside the range of the longitude of the azimuthal image, forming the compensation image according to the compensation area of the azimuthal image; and co-projecting the azimuthal image and the compensation image into the map projection image by a map projection method.

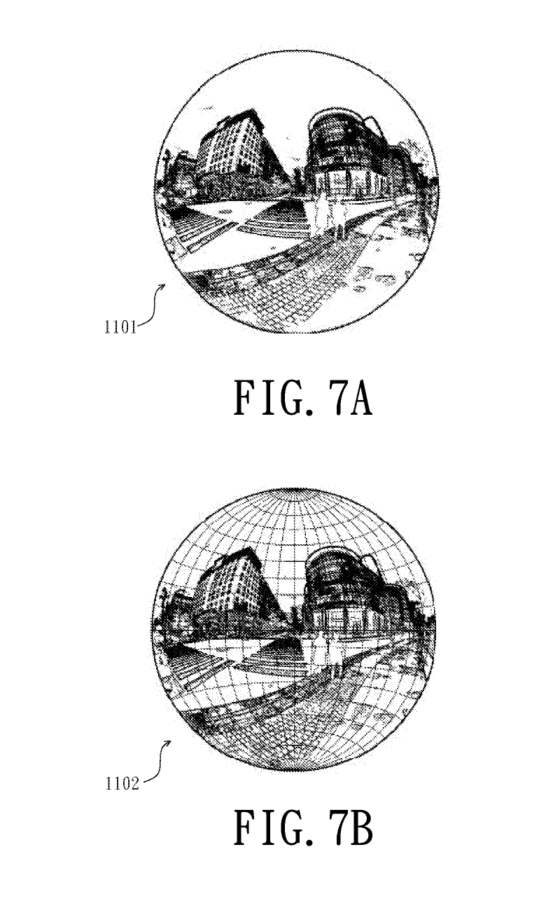

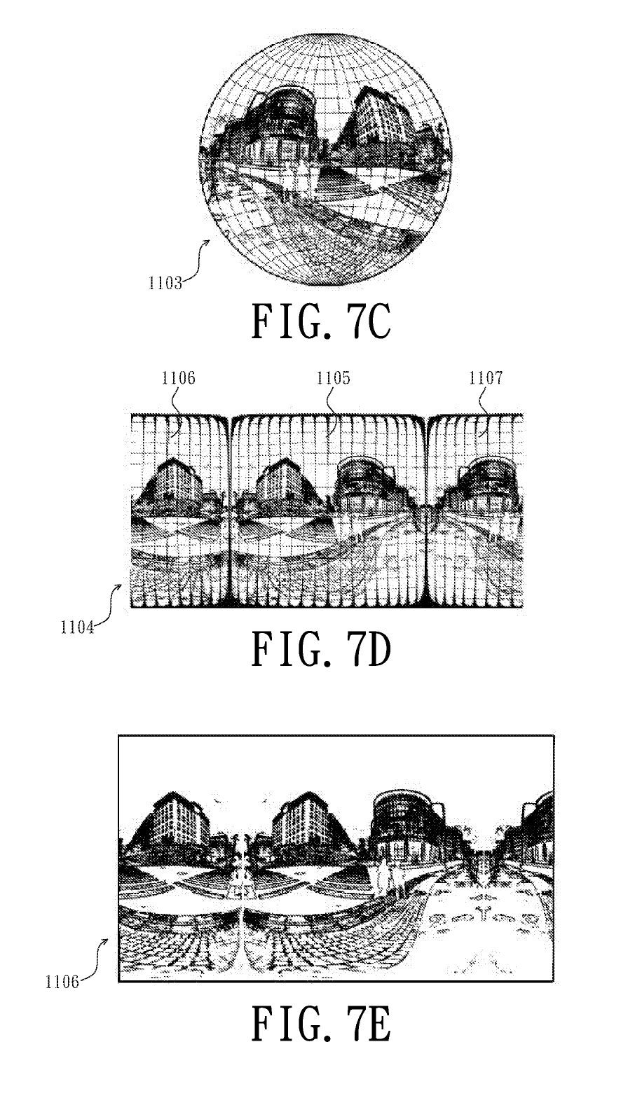

The map projection image is a projection, a cylindrical projection image, an equirectangular image, or others. Taking an equirectangular image as an example with figures that is for describing the method for transforming the wide-angle image to the map projection image. Referring to FIG. 7A and the step S101, which present that of capturing a wide-angle image 1101, and the wide-angle image 1101 is a full circle wide-angle image.

Continuously referring to FIG. 7B and step S102, which present that of choosing an azimuthal coordinate model and introducing the wide-angle image into the chosen azimuthal coordinate model in order to obtain an azimuthal image 1102. The azimuthal coordinate model in FIG. 7B takes an equidistant projection as an example, and the range of longitude is between −90° and 90°, and the other range of latitude is between −90° and 90° as well.

According to step S103, the compensation image is generated by using the azimuthal image 1102, so as to generate the equirectangular image. The range of the longitude of the azimuthal image 1102 is to 180°, and the equirectangular image's is up to 360°, therefore the preferred range limit of the longitude of the compensation area outside the range of the longitude of the azimuthal image 1102, is to 180°. That is, the preferred range of the longitude of a compensation image 1103 formed on the compensation area is to 180° as well, shown in FIG. 7C. Continuously, by way of taking an equirectangular projection method as the map projection method, the azimuthal image 1102 and the compensation image 1103 are co-projected into an equirectangular image 104, as shown in FIG. 7D. Due to the ranges of the longitudes of the azimuthal image 1102 and the compensation image 1103 being 180°, the equirectangular can be filled out. As shown in FIG. 7D, a symbol 1105 represents an image that is the azimuthal image 1102 being projected into the equirectangular, and two symbols 1106 and 1107 show two images that are the compensation image 103 being projected into the equirectangular. To eliminate the longitudes and latitudes in FIG. 7 may obtain an equirectangular image in FIG. 7E.

The compensation image 103 is a mirror projection image or a duplicate projection image of the azimuthal image 1102, and the present embodiment takes a mirror projection image as an example. f(λ, φ) is defined as a projection function of the azimuthal image 1102 projected into the map projection image, λ and φ are a longitude and a latitude respectively, f′(λ, φ) is defined as a compensation function of the compensation area, the relationships of the mirror projection image and the azimuthal image are as that of:

$${f}^{′} ( λ , ψ ) = \{ \begin{matrix}f ( π - λ , ψ ) , & λ ≧ π / 2 \\ f ( - π - λ , ψ ) , & λ ≦ - π / 2\end{matrix} , , \qquad equation ( 1 )$$

and
the relationships of the duplicate projection image and the azimuthal image are as that of:

$${f}^{′} ( λ , ψ ) = \{ \begin{matrix}f ( - π + λ , ψ ) , & λ ≧ π / 2 \\ f ( π + λ , ψ ) , & λ ≦ - π / 2\end{matrix} , . \qquad equation ( 2 )$$

For the method of the embodiment, there could be one more step that is horizontally displacing the equirectangular image, as defined by the map projection image, by means of the two functions of f(λ+λ₀, φ) and f′(λ+λ₀, φ), wherein the λ₀ is defined as a longitude displacement angle and the map projection method is an equirectangular projection method, as shown in FIG. 7D.

Following will introduce a plurality of projection functions of the azimuthal coordinate model projected into the equirectangular. Since those projection functions are well known for the skilled persons, those projection functions of the plurality of azimuthal coordinate models may not be fully displayed.

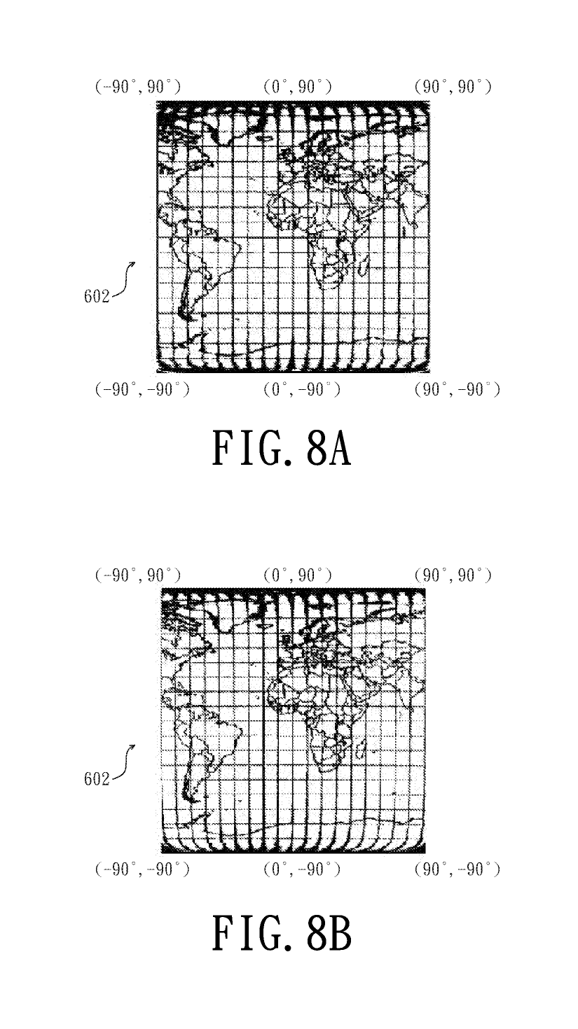

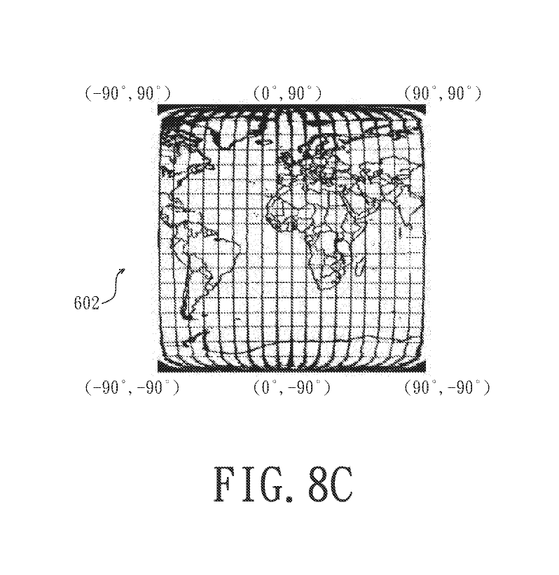

Taking the azimuthal equidistant projection as the azimuthal coordinate model is a preferred embodiment. Let ψ₁ and λ₀ represent the reference longitude and latitude of the center of an azimuthal image 601 respectively, as shown in FIG. 5A. A projection function from the azimuthal image 601 to a rectangular image 602 in FIG. 8A is represented as:

x=k cos(ψ)cos(λ−λ₀), equation (3), and

y=k[cos ψ₁ sin(ψ)−sin ψ₁ cos(ψ)cos(λ−λ₀)], equation (4),

wherein

$$k = \frac{c}{sin ( c )} , , \qquad equation ( 5 )$$

cos(c)=k[sin(ψ₁)sin(ψ)−sin(ψ₁)cos(ψ)cos(λ−λ₀)], equation (6).

“x” and “y” are two positions of λ and ψ on the Cartesian coordinate system. FIG. 8A represents an output result when λ₀=0 and ψ₁=0.

Taking the azimuthal stereographic projection as the azimuthal coordinate model is another preferred embodiment. Let ψ₁ and λ₀ represent the reference longitude and latitude of the center of an azimuthal image 801 respectively, as shown in FIG. 5B. A projection function from the azimuthal image 801 to a rectangular image 802 in FIG. 8B is represented as:

x=k cos(ψ)cos(λ−λ₀), equation (7), and

y=k[cos ψ₁ sin(ψ)−sin ψ₁ cos(ψ)cos(λ−λ₀)], equation (8),

wherein,

$$k = \frac{2 R}{1 + sin ( {ψ}_{1} ) sin ( ψ ) + cos ( ψ ) cos ( {ψ}_{1} ) cos ( λ - {λ}_{0} )} , , \qquad equation ( 9 )$$

wherein R is a local radius, Re is a radius on the equator, and R is represented by an equation as:

$$k = \frac{Re cos ( ψ )}{( 1 - {e}^{2} {sin}^{2} ( ψ ) ) cos ( )} , , \qquad equation ( 10 )$$

wherein [symbol] is a latitude which keeps appearance itself.
“x” and “y” are two positions of λ and ψ on the Cartesian coordinate system. FIG. 8B represents an output result when λ₁=0 and ψ₁=0.

Besides, taking the azimuthal orthographic projection as the azimuthal coordinate model is another preferred embodiment. A rectangular image 702 in FIG. 8C is transformed from an azimuthal image 701 in FIG. 5C, wherein λ₁=0 and ψ₁=0. The projection equations for the embodiment are:

x=cos(ψ)sin(λ−λ₀), and

y=[cos ψ₁ sin(ψ)−sin ψ₁ cos(ψ)cos(λ₀),

wherein “x” and “y” are two positions of λ and ψ on the Cartesian coordinate system.

Aforesaid azimuthal stereographic projection is applied to the equatorial aspect, as shown in FIG. 6. Further, the present invention is capable of applying to the polar aspect, as shown in FIG. 6A, and the oblique aspect, as shown in FIG. 6C, and only changing the reference values of λ₀ and ψ₁.

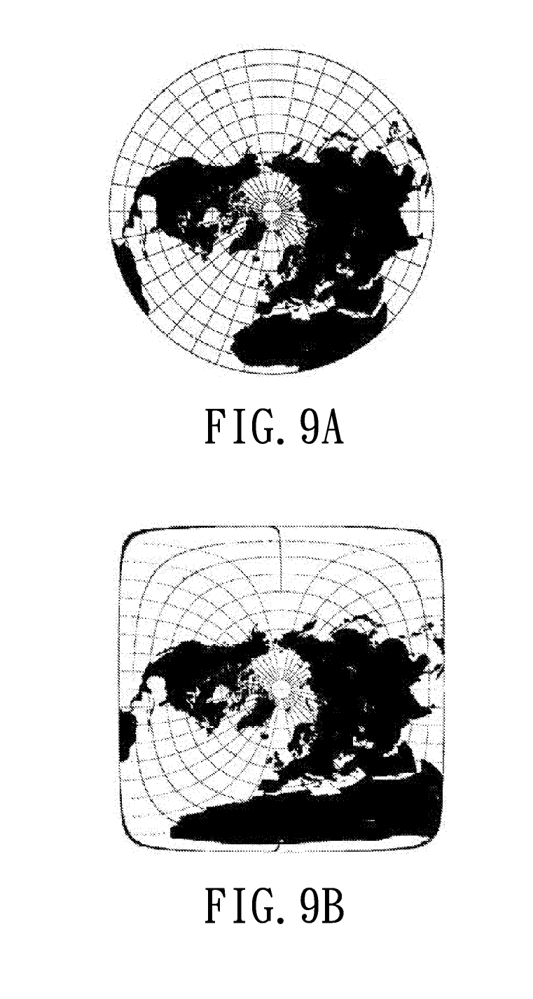

For instance, an azimuthal image 901 in FIG. 9A is an azimuthal equidistant projection applied to the polar aspect. FIG. 9B shows that the azimuthal image 901 is output to become a rectangular image 902 by way of equation (3) to equation (6), wherein λ₀=0, and ψ₁=90°.

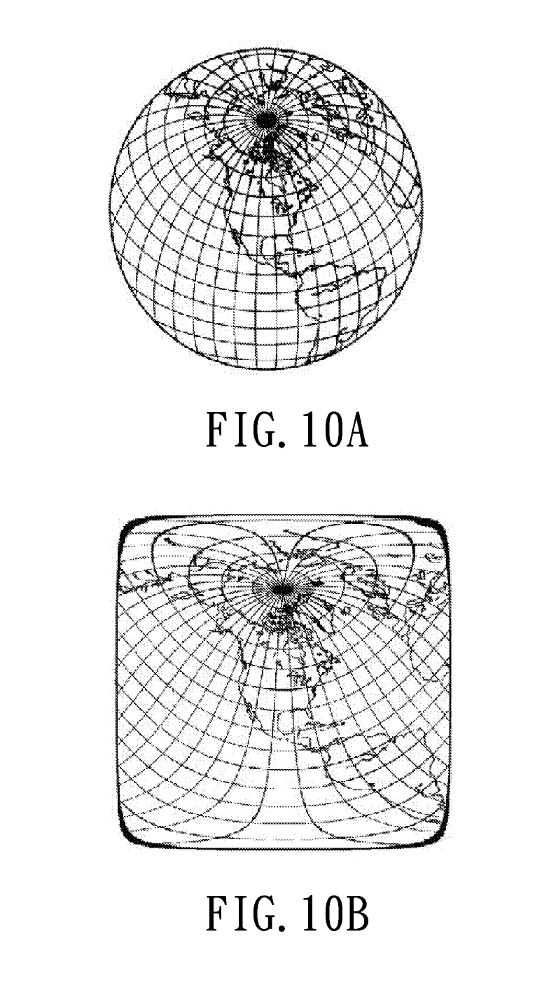

An azimuthal image 1001 in FIG. 10A is an azimuthal equidistant projection applied to the oblique aspect. FIG. 10B shows that the azimuthal image 1001 is output to become a rectangular image 1002 by way of equation (3) to equation (6), wherein λ₀=−75°, and ψ₁=45°.

As it can be seen, the present invention is suitable for those azimuthal coordinate models, that is, obtaining the equations of the azimuthal image projected to the rectangular image is a solution. The present invention can then be applied to the azimuthal aspects of the different types of azimuthal coordinate models, such as the azimuthal aspects from FIG. 6A to FIG. 6B.

Besides, the method for transforming the wide-angle image to the map projection image further comprises the step of referring to the coordinates of the longitude and the latitude of a position to obtain a new map projection image while the map projection image is dynamically changed. For instance, dynamically changing the longitude λ₀ is able to let an output image be added an 360-degree leveling and rotating effect.

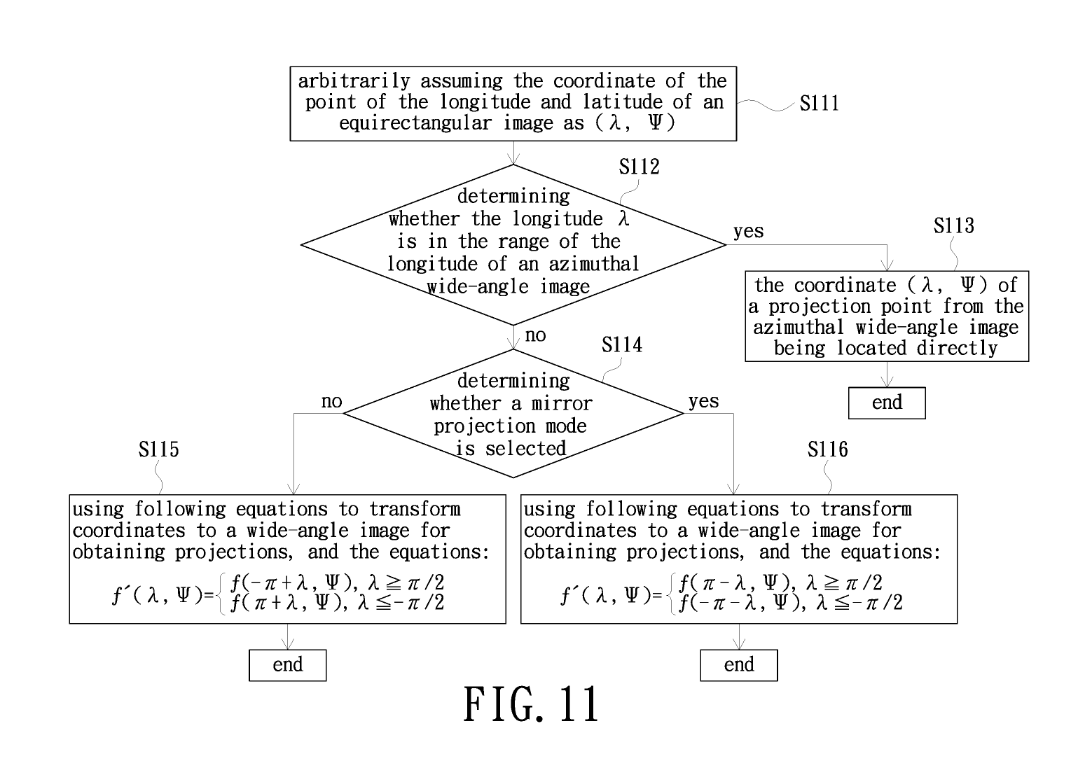

With reference to FIG. 11, which illustrates a flow chart of a method for transforming an azimuthal image to an equirectangular image of the present invention. As shown in FIG. 11, a step S111 is that of arbitrarily assuming the coordinate of the point of the longitude and latitude of an equirectangular image as (λ, ψ). Continuously, a step S112 is that of determining whether the longitude λ is in the range of the longitude of an azimuthal image. If yes, a step S113 is executed, that is, the coordinate (λ, ψ) of a projection point from the azimuthal image is located directly; on the other hand, it means that the longitude λ is in a compensation area, and determining whether a mirror projection mode is selected, as shown in a step S114. If no, the duplicate projection mode is proceeded, as shown in a step S115; otherwise, a step S116 may then be executed.

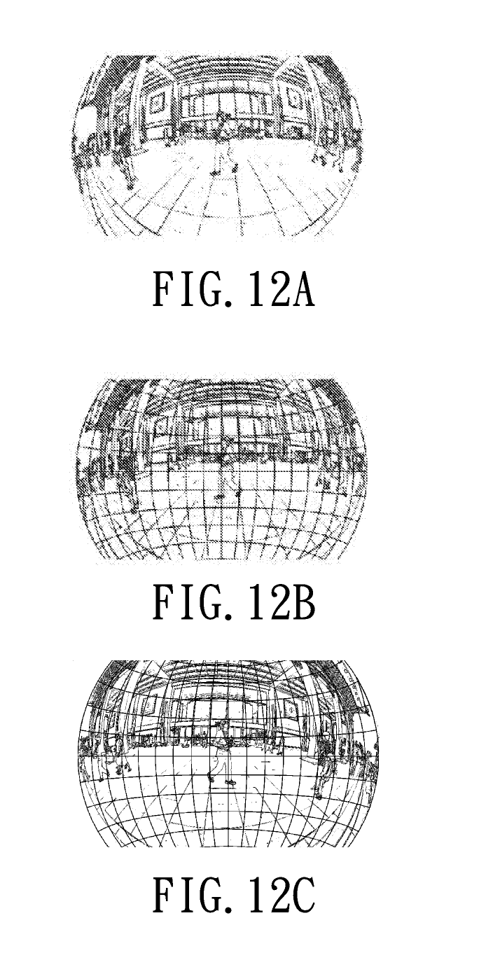

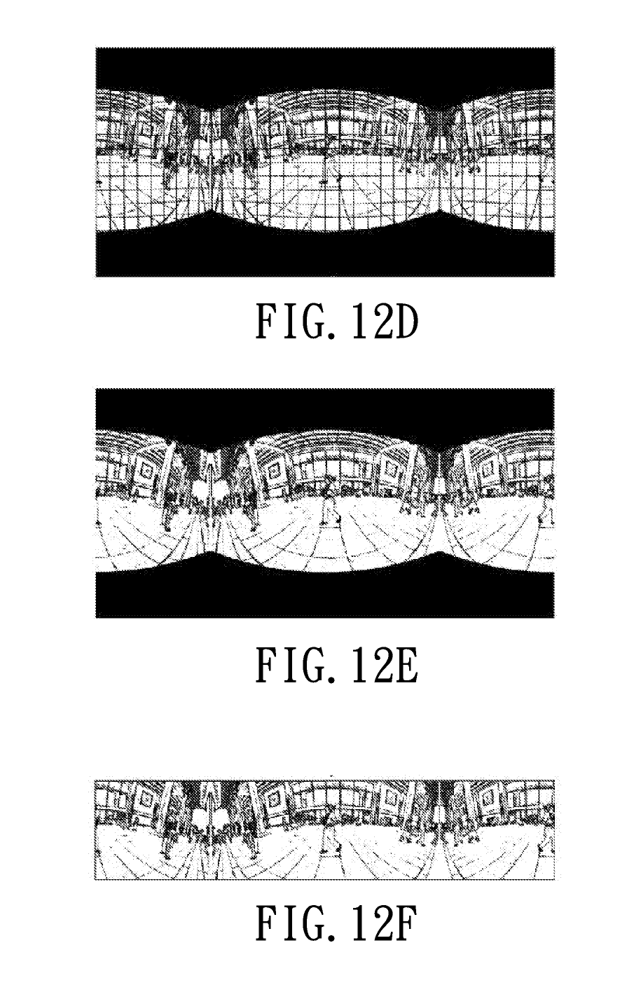

FIG. 12A to FIG. 12E illustrate a flow chart of a preferred embodiment of a method for transforming a wide-angle image to a map projection image of the present invention. The steps of FIG. 12A to FIG. 2E are similar to the steps of FIG. 7A to FIG. 7E, but the wide-angle image in FIG. 12A is a rounded rectangular image as an example. Hence, the transformed equirectangular image in FIG. 12E may happen blocks not corresponding to the wide-angle image. Further, the method of transforming the wide-angle image to the map projection image shall include the step of cropping a vertical section for the latitude ψ range of −90° to 90° of the equirectangular image to output a cylindrical projection image. That is, the blocks not corresponding to the wide-angle image is cut, so as to obtain an equirectangular image, as shown in FIG. 12F.

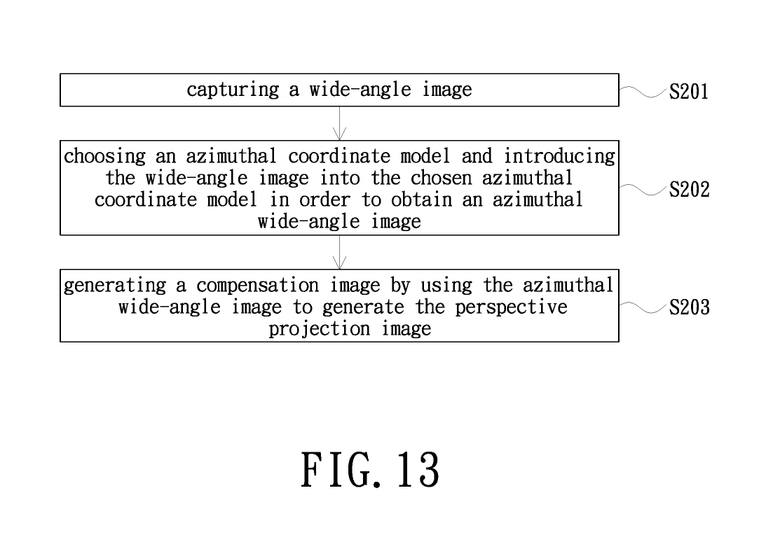

FIG. 13 illustrates a flow chart of a preferred embodiment of a method for transforming a wide-angle image to a map projection image of the present invention. As shown in figure, the method of transforming a single wide-angle image to a map projection image has the steps of: capturing a wide-angle image, as shown in a step S201, and choosing an azimuthal coordinate model and introducing the wide-angle image into the chosen azimuthal coordinate model in order to obtain an azimuthal image, as shown in a step S202 (The step S201 and step S202 are similar to aforesaid step S101 and step S102, and they will not be described any further hereinafter); and generating a compensation image by using the azimuthal image for the perspective projection image, as shown in a step S203.

In detail, the step S203 further includes the steps of: defining the compensation area outside the range of the longitude of the azimuthal image, forming the compensation image according to the compensation area of the azimuthal image; and co-projecting the azimuthal image and the compensation image into the map projection image by a perspective projection method.

For the preferred embodiment, the range of the longitude of the azimuthal image is 180° and the range of the longitude of the compensation image is 180°. The compensation image is a mirror projection image or a duplicate projection image, f(λ, ψ) is defined as a projection function of the azimuthal image projected into the perspective projection image, λ and ψ are a longitude and a latitude respectively, f′(λ, ψ) is defined as a compensation function of the compensation area. The relationship of the mirror projection image and the azimuthal image refers to aforesaid equation (1), and the relationship of the duplicate projection image and the azimuthal image refers to aforesaid equation (2). More, the perspective projection method defines a sphere center as a view direction.

For another preferred embodiment, the method for transforming the wide-angle image to the perspective projection image has the step of: dynamically changing a longitude, a latitude and a horizontal field of view angle of a view direction while in perspective projection, in order to obtain a new perspective projection image.

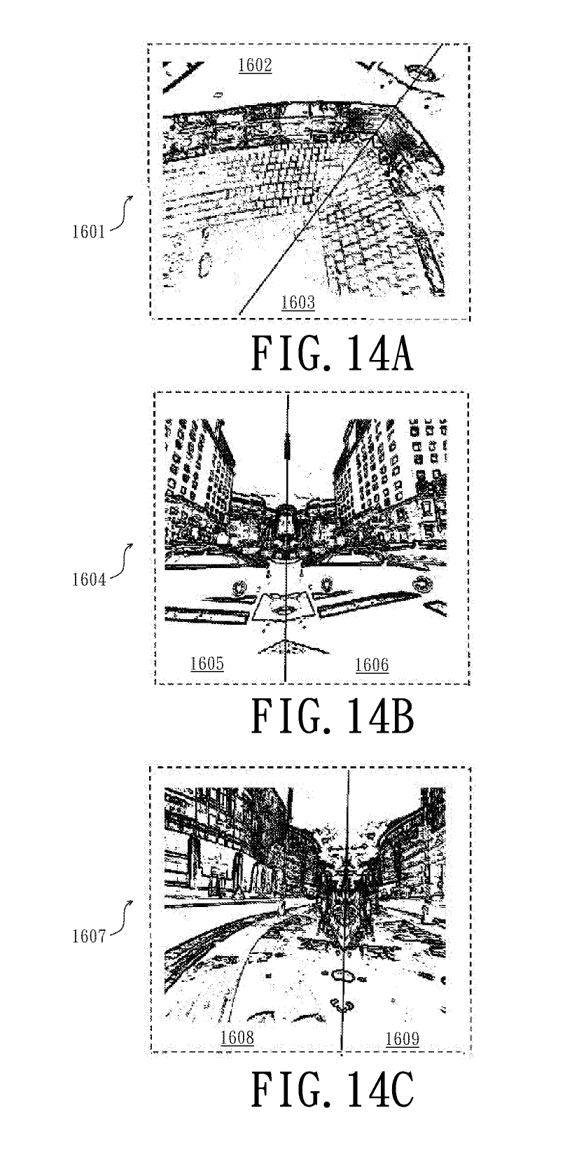

Immersive virtual reality is actually a perception in the nonphysical world. The perception is an image that is around the virtual reality system, so as to create an attractive environment as light, sound, etc. for users. FIG. 14A to FIG. 14C illustrate three different perspective projection views of transforming the wide-angle image to the map projection image of the preferred embodiment of the present invention. Symbols 1602, 1606 and 1608 are three projection images from the wide-angle image. Other symbols 1603, 1605 and 1609 are from the compensation area.

A subroutine program listed below may help to obtain all projection points of projecting the azimuthal image to the perspective projection image. In the subroutine program, “height” represents the height of an output perspective projection image, that is, an image point number along the vertical direction, and “width” is defined as the width of the output perspective projection image, which is another image point number along the horizontal direction. The subroutine program is as following:

```
    $M [ 3 ] [ 3 ] = ( \begin{matrix}1 & 0 & 0 \\ 0 & cos ( λ ) & sin ( λ ) \\ 0 & - sin ( λ ) & cos ( λ )\end{matrix} ) ( \begin{matrix}cos ( ψ ) & sin ( ψ ) & 0 \\ - sin ( ψ ) & cos ( ψ ) & 0 \\ 0 & 0 & 1\end{matrix} )$
    cx = −(width − 1)/2
    cy = −height/2
    α₁ = M[1][0] × cy + M[2][0]
β₁ = M[1][1] × cy + M[2][1]
γ₁ = M[2][2] × cy + M[2][2]
    for (i = 0; i< height; i++) {
      α₂ = M[0][0] × cy + α₁
      β₂ = β₁
      γ₂ = M[0][2] × cy + γ₁
      for (j = 0; j < width; j++) {
        λ = arctan2(α₂, γ₂)
        ψ = arctan2(β₂, sqrt(abs(α₂), abs(γ₂)))
      //obtain the values of the longitude and latitude of all projection
  points on the azimuthal image
        α₂ += M[0][0]
        γ₂ += M[0][2]
      }
  α₁ += M[1][0]
β₁ += M[1][1]
  γ₁ += M[1][2]
  }
λ = arctan2(α₂, γ₂) ;
ψ = arctan2(β₂, sqrt(abs(α₂), abs(γ₂)))
```

Therefore, every perspective projection point on the azimuthal image can be obtained. The coordinate (λ, φ) of the real projection points (x, y) on the Cartesian coordinate can then be obtained through aforesaid equation (3) to equation (10).

The wide-angle image in the methods of the present invention is a single or a plurality of images captured from a single image source; on the other hand, the steps of using the azimuthal image to generate the compensation image do not require image stitching commonly adopted in the prior art, so that a virtual reality image is easily obtained.

Although the invention has been disclosed and illustrated with reference to particular embodiments, the principles involved are susceptible for use in numerous other embodiments that will be apparent to persons skilled in the art. This invention is, therefore, to be limited only as indicated by the scope of the appended claims

What is claimed is:

1. A method for transforming a wide-angle image to a map projection image comprising steps of:
capturing the wide-angle image;
choosing an azimuthal coordinate model and introducing the wide-angle image into the chosen azimuthal coordinate model to obtain an azimuthal image; and
generating a compensation image by using the azimuthal image to generate the map projection image.

2. The method for transforming the wide-angle image to the map projection image according to claim 1, wherein the step of generating the compensation image by using the azimuthal image to generate the map projection image further comprises steps of:
defining a compensation area outside a range of a longitude of the azimuthal image, and forming the compensation image according to the compensation area of the azimuthal image; and
co-projecting the azimuthal image and the compensation image into the map projection image by a map projection method.

3. The method for transforming the wide-angle image to the map projection image according to claim 2, wherein the range of the longitude of the azimuthal image is 180°, and a range of a longitude of the compensation image is 180°.

4. The method for transforming the wide-angle image to the map projection image according to claim 2, wherein the compensation image is a mirror projection image or a duplicate projection image, f(λ, ψ) is defined as a projection function of the azimuthal image projected into the map projection image, λ and ψ are a longitude and a latitude respectively, f′(λ, ψ) is defined as a compensation function of the compensation area, a relationship of the mirror projection image and the azimuthal image is:
$${f}^{′} ( λ , ψ ) = \{ \begin{matrix}f ( π - λ , ψ ) , & λ ≧ π / 2 \\ f ( - π - λ , ψ ) , & λ ≦ - π / 2\end{matrix} ,$$
and
a relationship of the duplicate projection image and the azimuthal image is:
$${f}^{′} ( λ , ψ ) = \{ \begin{matrix}f ( - π + λ , ψ ) , & λ ≧ π / 2 \\ f ( π + λ , ψ ) , & λ ≦ - π / 2\end{matrix} .$$

5. The method for transforming the wide-angle image to the map projection image according to claim 4, further comprising a step of: horizontally displacing an equirectangular image by functions of f(λ+λ₀, Φ) and f′(λ+λ₀, Φ), wherein λ₀ is a longitude displacement angle, the map projection method is an equirectangular method, and the map projection image is an equirectangular image.

6. The method for transforming the wide-angle image to the map projection image according to claim 2, further comprising a step of: cropping a vertical section from a longitude range of −90° to 90° of an equirectangular image to output a cylindrical projection image, wherein the map projection method is an equirectangular projection method and the map projection image is an equirectangular image.

7. The method for transforming the wide-angle image to the map projection image according to claim 2, further comprising a step of: referring to coordinates of a longitude and a latitude of a position to obtain a new map projection image while the map projection image is dynamically changed.

8. The method for transforming the wide-angle image to the map projection image according to claim 2, wherein the map projection image is selected from a group consisting of: the azimuthal image, a cylindrical projection image and an equirectangular image.

9. The method for transforming the wide-angle image to the map projection image according to claim 1, wherein the azimuthal coordinate model is selected from a group consisting of: azimuthal equidistant projection, azimuthal stereographic projection and azimuthal orthographic projection.

10. A method for transforming a wide-angle image to a perspective projection image comprising steps of:
capturing the wide-angle image;
choosing an azimuthal coordinate model and introducing the wide-angle image into the chosen azimuthal coordinate model to obtain an azimuthal image; and
generating a compensation image by using the azimuthal image to generate the perspective projection image.

11. The method for transforming the wide-angle image to a perspective projection image according to claim 10, wherein the step of generating the compensation image by using the azimuthal image to generate the perspective projection image further comprises steps of:
defining a compensation area outside a range of a longitude of the azimuthal image, and forming the compensation image according to the compensation area of the azimuthal image; and
co-projecting the azimuthal image and the compensation image into the map projection image by a perspective projection method.

12. The method for transforming the wide-angle image to the perspective projection image according to claim 11, wherein the range of the longitude of the azimuthal image is 180°, and the range of the longitude of the compensation image is 180°.

13. The method for transforming the wide-angle image to the perspective projection image according to claim 11, wherein the compensation image is a mirror projection image or a duplicate projection image, f(λ, ψ) is defined as a projection function of the azimuthal image projected into the perspective projection image, λ and ψ are a longitude and a latitude respectively, f′(λ, ψ) is defined as a compensation function of the compensation area, a relationship of the mirror projection image and the azimuthal image is:
$${f}^{′} ( λ , ψ ) = \{ \begin{matrix}f ( π - λ , ψ ) , & λ ≧ π / 2 \\ f ( - π - λ , ψ ) , & λ ≦ - π / 2\end{matrix} ,$$
and
a relationship of the duplicate projection image and the azimuthal image is:
$${f}^{′} ( λ , ψ ) = \{ \begin{matrix}f ( - π + λ , ψ ) , & λ ≧ π / 2 \\ f ( π + λ , ψ ) , & λ ≦ - π / 2\end{matrix} .$$

14. The method for transforming the wide-angle image to the perspective projection image according to claim 11, wherein the perspective projection method defines a sphere center as a view direction.

15. The method for transforming the wide-angle image to the perspective projection image according to claim 11 further comprising a step of: dynamically changing a longitude, a latitude and a horizontal field of a view angle of a view direction to obtain a new perspective projection image.

16. The method for transforming the wide-angle image to the perspective projection image according to claim 10, the azimuthal coordinate model is selected from a group consisting of: azimuthal equidistant projection, azimuthal stereographic projection and azimuthal orthographic projection.
